(19) United States
(12) Patent Application Publication
(10) Pub. No.: US 2026/0216879 A1
(43) Pub. Date: Jul. 30, 2026

(54) SAFETY REDUNDANCY AND TRAINING FOR EMBODIED AGENT PLANNING

(71) Applicant: GDM Holding LLC, Mountain View, CA (US)

(72) Inventor: Pierre Sermanet, San Francisco, CA (US)

(21) Appl. No.: 19/425,312

(22) Filed: Dec. 18, 2025

Related U.S. Application Data
(60) Provisional application No. 63/749,411, filed on Jan. 24, 2025.

(51) Int. Cl. B25J 9/16; B25J 13/00; G06V 20/50

(52) U.S. Cl. CPC B25J 9/1689; B25J 9/163; B25J 9/1674; B25J 9/1697; B25J 13/003; G05B 2219/39001; G06V 20/50

(57) ABSTRACT

Implementations are provided for safety redundancy and training for embodied agent planning. In various implementations, a safety agent process may obtain visual representation(s) of a robot interacting with an environment. The robot may be controlled at least in part based on commands generated by a robotic planner process that is executed by one or more of the processors. The safety agent process may assemble, as a safety agent input prompt, data indicative of the one or more visual representations. The safety agent process may cause the safety agent input prompt to be processed using a vision language model (VLM) to generate VLM output. Responsive to the VLM output including alternative command(s) for the robot, the safety agent process may generate a control signal for the robot based on the one or more alternative commands.

### BACKGROUND

“Base,” “foundational” generative models such as vision language models (VLMs) may be used by robotic planner processes to process one or more modalities of data, such as text and image(s), to generate commands to be performed by an embodied agent, such as a human, or a real or simulated robot. In some cases these commands may be expressed in natural language. Even without being fine-tuned for specific scenarios, these base generative models may be reasonably capable of generating commands that are unlikely to result in damage to the embodied agent or its environment in most contexts. However, when faced with specific contexts that were not encountered during training, these base generative models may generate commands to engage in behavior that is potentially deleterious, inefficient, and/or that fails to accomplish a stated goal of the embodied agent.

Separately, many video conference tools provide infrastructure for real time video streaming, multi-participants, and high-quality speech transcription for population of transcripts and/or message exchange threads provided as part of video conferences.

### SUMMARY

Implementations are described herein for providing redundancy to generative model-based planning for embodied agents, particularly robots (real or simulated). More particularly, but not exclusively, techniques are described herein for training and deploying one or more distinct agent processes, such as a safety agent process, safety adversary process, and/or a “dreaming” agent process that operate independently a robotic planner process. The safety agent process may be configured to process data indicative of a robot and/or its environment using a generative model such as a VLM (which may be the same as that used by the robotic planner process or different). Based on generative model output, the safety agent process may detect an imminent undesirable state of the environment and/or provide alternative commands for the robot that will avoid or reduce the likelihood of the imminent undesirable state occurring. In various implementations, alternative commands from the safety agent process may supersede or otherwise override commands generated by the robotic task planner.

The safety adversary process may be configured to propose instructions that are close to, or even within, unsafe or undesirable region(s) of an action space. The embodied agent (e.g., human or robot) receiving the instructions proposed by the safety adversary process may not be intended to execute the instructions if they are unsafe. Rather, the embodied agent can take these instructions proposed by the safety adversary process as guidelines or inspiration to approach a boundary in action space from which data may be sampled. In some cases it may be assumed that the embodied agent is an expert, for example a human operator teleoperating a robot, that already knows what is reasonably safe to execute or not during data collection. In some implementations, the input to the safety adversary process may include image(s) (e.g., video) of a current scene, and the output may include a textual command to the embodied agent.

In some implementations, a distinct simulation training process (also referred to as a “dreaming agent”) may be configured to, through simulation (or “dreaming”), sample training examples for deleterious behavior (e.g., far outside the boundary between deleterious and non-deleterious behavior) in which the embodied agent is or has engaged in deleterious behavior. This may enable sampling of training examples for deleterious behavior without risking physical embodied agents or their environments. The inputs to a dreaming agent may include, for instance, image(s) (e.g., video) of an unsafe or undesirable outcome, and the output may include a textual command to the embodied agent. Implementation of a dreaming agent is similar in spirit to bad dreams humans experience at night, which are theoretically meant to prepare humans for dangers that they cannot experience in real life. Similarly, techniques described herein enable collection of data near the safe/unsafe or desirable/undesirable boundaries on the safe side at low cost. However, crossing to the unsafe/undesirable portion of action space may come with a big cost if implemented in the real world. Accordingly, simulation and imagination are desirable and enable an agent such as the dreaming process described herein to visualize what catastrophic situations look like, and hence, can plan to avoid them.

Techniques described herein give rise to various technical advantages and benefits. Leveraging video conferencing enables far more efficient, fast, and less costly collection of training data for training, for instance, generative language models that predict mid-level actions for carrying out high-level tasks. Providing a separate safety agent process to monitor robotic operation and/or provide a redundant safety measure to a robotic planner process may enable a generative model used by the safety agent process to be trained and/or fine-tuned separately. This may be beneficial if a “trunk” generative model used by the robotic planner process is more general purpose in natural, less easily trained (e.g., due to large size), less accessible (e.g., it may be locked from training so that it remains consistent across multiple different organizations), etc. In some cases, the safety generative model used by the safety agent process may have fewer parameters than the trunk generational model, which expedites both training and inference.

Additionally, in many scenarios, robotic operation may be subject to official safety certifications. It may be beneficial to train/fine-tune and/or separately store a safety generative model that is used only by the safety agent process (and not by the robotic planner process). That way, the safety generative model can be certified for safety on its own, avoiding the need to subject the trunk model to such scrutiny and/or heightened safety standards. Similarly, having a separate safety generative model that is specifically optimized for safety/redundancy purposes may allow for the more general trunk model to be optimized for general efficiency and/or likelihood of successfully performing tasks, rather than for safety.

### BRIEF DESCRIPTION OF THE DRAWINGS

FIG. 1 schematically depicts an example environment in which disclosed techniques may be employed, in accordance with various implementations.

FIG. 2 depicts an example robot, in accordance with various implementations.

FIG. 3 schematically depicts an example of how various components depicted in FIG. 1 may cooperate to carry out selected aspects of the present disclosure.

FIG. 4 schematically depicts an example of how techniques described herein may be implemented to sample training examples from various points in latent affordance space.

FIG. 5A, FIG. 5B, and FIG. 5C schematically depict an example of how techniques described herein may be implemented using a video conference session.

FIG. 6 depicts an example method for practicing selected aspects of the present disclosure.

FIG. 7 depicts an example method for practicing selected aspects of the present disclosure.

FIG. 8 depicts an example method for practicing selected aspects of the present disclosure.

FIG. 9 schematically depicts an example architecture of a computer system.

### DETAILED DESCRIPTION

Implementations are described herein for providing redundancy to generative model-based planning for embodied agents, particularly robots (real or simulated). More particularly, but not exclusively, techniques are described herein for training and deploying one or more distinct agents, such as a safety agent process that operates alongside (and independently of) a robotic planner process to process sensor data indicative of a robot and/or its environment using a generative model such as a VLM (which may be the same as that used by the robotic planner process or different). Based on generative model output, the safety agent process may detect an imminent undesirable state of the environment and/or provide alternative commands for the robot that will avoid or reduce the likelihood of the imminent undesirable state occurring. In various implementations, alternative commands from the safety agent process may supersede or otherwise override commands generated by the robotic task planner.

In various implementations, a safety agent process may be operated by one or more processors integrated with the robot or deployed elsewhere. In some implementations, the safety agent process may be operated in a secure subsystem of the robot, such as an embedded secure element (eSE) or the like, which may include one or more processors and/or memory that are isolated from other hardware that controls the robot. This secure subsystem may be tamper-proof and/or accessible only to authorized personnel. In some such implementations, one or more generative models that are used by the safety agent process, such as VLMs, image generator models, etc., may be stored in memory within this secure subsystem.

In various implementations, the safety agent process may be configured to obtain visual representations of the robot interacting with its environment from various sources. These sources may include vision sensor(s) onboard the robot, vision sensor(s) deployed in the robot's environment, virtual vision sensors that are deployed in a simulated environment, databases that are used to store visual representations of robots interacting with environments, and so forth. Visual representations may take various forms as well, such as two-dimensional (2D) digital images, three-dimensional (3D) representations such as 3D digital images or point clouds (e.g., generated by LIDAR sensors), and so forth.

The safety agent process may be configured to leverage these visual representations and VLM(s) to monitor robot behavior, and intercede where appropriate to prevent the robot from engaging in deleterious behavior. For example, the safety agent process may be configured to process the visual representation(s) using a VLM to generate VLM output. This VLM output may include alternative commands for the robot (real or simulated) to perform, in place of and/or in addition to commands, generated by a separate robotic planner process, that the robot already has performed, is performing, or will perform.

The safety agent process may then cause a control signal to be generated for the robot based on the one or more alternative commands. For example, in some implementations, the safety agent process may provide the one or more alternative commands to the robotic planner process, e.g., with an annotation that signals to the robotic planner process that the alternative commands should supersede, or at least be used in addition to, the commands the robotic planner process had already generated. These alternative commands may prevent or at least reduce the likelihood that the robot (or more generally, embodied agent) will engage in deleterious behavior that it might otherwise if it simply followed the commands generated by the robotic planner process.

The robotic planner process may then take various actions, such as replacing its own command(s) with the alternative commands generated by the safety agent process, generating a control signal based on the alternative commands, providing the alternative commands (in addition to or instead of its own command) to a robot control data generation process that is executed independently from the robotic planner process and/or safety agent process, etc. In some cases, the robot control data generation process may utilize a robot control data machine learning model to generate robot control data from commands (e.g., natural language statements) generated by robotic planner process and/or safety agent process. An example of a robot control data machine learning model that may be used is described in “RT-1: Robotics Transformer for Real-World Control at Scale” (arXiv: 2212.06817).

Additionally or alternatively, in some implementations, the safety agent process may be configured to provide the alternative command(s) directly to the robot control data generation process. In yet other implementations, the safety agent process may generate the control signal itself, e.g., using a robot control data machine learning model. In some such implementations, the safety agent process may provide the control signal to the robot directly.

As a working example, suppose a high level command for a robot is to pick up a coffee mug that is resting near the edge of a table. When processing this high level command, the robotic planner process may generate mid-level actions (e.g., natural language statements) to carry out constituent portions of the larger task (e.g., “move towards table,” “open gripper,” “extend arm towards coffee mug,” “close gripper,” etc.). In an attempt at efficiency, the mid-level actions generated by the robotic planner process might be configured to cause the robot to approach the coffee mug in the most direct way possible. However, the most direct approach may also be more likely to result in the robot knocking the coffee mug off the table than if the robot were to approach the coffee mug using a more circuitous route.

When using the VLM to process the sequence of images (e.g., video frames) showing the robot approaching the coffee mug in the most direct way, the safety agent process may determine, based on VLM output generated from one or more of the frames, that an imminent undesirable state of the environment is detected-namely, that the robot is about to, or at least likely to, accidentally push the coffee mug off the table. In some implementations, the VLM output may only include an indication (e.g., a measure of concern or risk) of the imminent undesirable state, which may then trigger the safety agent process to assemble the visual representation(s) into an additional input prompt (e.g., along with request for alternative commands to avoid the imminent undesirable state) that the safety agent then processes using the VLM. In other implementations, however, and to preserve computing resources, the initial VLM output may also include, in addition to the indication of the imminent undesirable state, one or more alternative commands that if followed by the robot, would avoid or reduce the likelihood of the imminent undesirable state. In some implementations, the input prompt may also include a request for—and the resulting VLM output may include—an explanation or description of the imminent undesirable state (e.g., “the mug is likely to be knocked off the table if approached from that direction”).

The safety agent process and the robotic planner process may communicate and/or cooperate in various ways. In some implementations, the safety agent process and the robotic planner process may be enrolled as participants of a video conference session. Video conference client(s) associated with the video conference session may render, as output, sensor feed(s) that may include, for instance, the visual representation(s) (e.g., images, point clouds) of the robot interacting with the environment. This may give participant(s) of the video conference session, such as safety agent process, access to the visual representation(s) so that it can generate alternative commands. In some implementations, these alternative commands may be incorporated by the safety agent process into a message exchange thread (e.g., a chat) facilitated by or otherwise associated with the video conference session. The robotic planner process, also acting as a participant in the video conference session, may receive these alternative commands and take appropriate action, as described above.

Alternatively, the robot control data generation process may be enrolled as another participant in the video conference session. This may allow the robot control data generation process to generate robot control data based on commands provided by both the robotic planner process and the safety agent process. As noted previously, alternative commands provided by the safety agent process may take priority over and/or supersede commands from the robotic planner process. In some implementations, other participants of the video conference session may include, for instance, the robot (or more generally, the embodied agent), as well as human experts that can incorporate their own alternative commands, explanations, corrections, etc., into the message exchange thread/video conference session. Thus, the video conference session effectively facilitates a committee of agents that cooperate to control the robot.

In various implementations, the safety agent process may use the same VLM as the robotic planner process or a different VLM. When using the same VLM, the safety agent process may prompt the VLM differently than the robotic planner process. For example, the safety agent process may assemble an input prompt that includes visual representations of the robot interacting with its environment and a textual snippet explaining the VLM's role and/or task (what should be predicted, what information should be considered when making the prediction), such as the following:
You are a safety officer tasked with detecting imminent undesirable, unsafe or dangerous situations. For example, an undesirable situation can be knocking a glass off a table which might spill liquid over, break and become dangerous. Do you see an imminent or currently undesirable situation in this image? Your response should be in the following strict format and include a reason and a fix. Example 1: undesirable=yes; reason=the knife blade is too close to the person's fingers; fix move the knife away from the fingers. Example 2: undesirable=no; reason=None; fix=None

Such a prompt may condition the VLM to generate output (e.g., indications of imminent risk, alternative commands) that is tailored towards avoiding imminent undesirable states of the robot or the environment. By contrast, the robotic planner process may assemble an input prompt that conditions the VLM to generate commands that are designed to cause the robot to accomplish the task at hand as efficiently as possible. The commands generated by the robotic planner process may be somewhat effective at avoiding deleterious behavior. By contrast, the alternative commands generated by the robot safety process may be more concerned with avoiding deleterious behavior and less concerned with robotic planning and/or efficiency, and therefore may be more effective at avoiding deleterious behavior. In some implementations, the robot safety process may be conditioned, for processing during a single iteration of the generative model, with the following prompt: (i) are the command(s) undesirable (yes/no); (ii) what is the reason?; and/(iii) what is the fix to make the command(s) desirable?

In other implementations, the safety agent process may use a different VLM (or more generally, generative model) than the robotic planner process. In this case, the “safety VLM” may be trained (e.g., pretrained and/or fine-tuned if already pretrained) to detect imminent undesirable states of the robot/environment and generate alternative commands (and in some cases, explanations of the imminent undesirable states) to avoid the undesirable states. In some such implementations, the safety VLM may begin as a copy of the VLM used by the robotic planner process, but may diverge during training/fine-tuning. In some implementations, the safety VLM may be a different architecture altogether and/or may be smaller or larger than the VLM used by robotic planner process.

As noted previously, the robotic planner process may be reasonably adept at generating mid-level actions that, if carried out, avoid risks to the robot or its environment in many contexts, and the safety agent process may be helpful to generate alternative commands in specific contexts unseen by the robotic planner process (or the VLM it uses). However, the VLM used by either process could be improved by sampling training data examples that lie both near the boundary between deleterious and non-deleterious behavior, as well as sampling training data examples that are entirely unsafe and thereby outside of this boundary.

To provide training data samples near the boundary between deleterious and non-deleterious behavior, in some implementations, a safety adversary process may be provided, e.g., as another participant in the video conference session, to attempt to sample training data near this boundary. In various implementations, the safety adversary process may assemble, into what will be referred to herein as a “boundary-seeking” input prompt, data indicative of the visual representations depicting the robot interacting with its environment, and a request to generate boundary-seeking command(s). The intent is for these boundary-seeking commands to be performable/performed by the robot to alter a state of the robot or its environment in a manner that increases a measure of risk to the robot or the environment, e.g., without the robot actually engaging in deleterious behavior. Put another way, once the boundary-seeking command(s) are implemented, the state of the robot and/or its environment will be closer to the boundary between deleterious and non-deleterious behavior, without going over that boundary.

In various implementations, the safety adversary process may cause the boundary-seeking input prompt to be processed using the same VLM as used by the safety agent process or robotic planner process, or a different VLM, to generate what will be referred to herein as “boundary-seeking” VLM output. The boundary-seeking VLM output may include the boundary-seeking command(s) for the robot to perform to transition a state of the robot and/or its environment to increase a measure of risk to the robot/environment. In some implementations, the safety adversary process may then cause a boundary-seeking control signal to be generated for the robot based on the boundary-seeking command(s).

Once the robot and/or environment is transitioned into this riskier state (e.g., the robot arm is perilously close to knocking a mug off of a table, or the robot is perilously close to falling over due to navigation towards a sloped surface), various data may be assembled into a boundary-adjacent training example. This data may include, for instance, one or more training visual representations that depict the robot or the environment after the robot is operated using the boundary-seeking control signal, and the increased measure of risk to the robot or the environment. One or more generative models, such as the VLM(s) used by the safety agent process or robotic planner process, may then be trained (e.g., pretrained and/or fine-tuned if already pretrained) based on the boundary-adjacent training data.

Operating the robot to increase a risk to the state of the robot or its environment, without crossing the boundary into unsafe behavior, may be beneficial for generating training data that can be used to train a generative model to generate more robust responses to risky situations. However, operating the robot (especially if not simulated) to engage in outright deleterious behavior may not be acceptable, e.g., due to safety concerns and/or costs/potential damages. Accordingly, in some cases, an embodied agent such as a human expert (e.g., teleoperating a robot) receiving instructions that would result in deleterious behavior is not intended to execute the instructions if they are unsafe to collect. Rather, the embodied agent can take the instructions as guidelines or inspiration to get closer to the boundary between deleterious and non-deleterious behavior to sample data.

However, it may yet be beneficial to sample training examples that lie outside of the boundary between deleterious and non-deleterious behavior, e.g., to allow the robot to better discern between deleterious and non-deleterious behavior. Accordingly, in various implementations, a simulation training process (also referred to as a “dreaming agent”) may be configured to, through simulation (or “dreaming”), sample training examples for deleterious behavior (e.g., far outside the boundary between deleterious and non-deleterious behavior) in which the robot is or has engaged in deleterious behavior. This may enable sampling of training examples for deleterious behavior without risking physical robots or their environments.

In various implementations, the simulation training process may assemble, as a negative outcome-seeking input prompt, data indicative of the visual representations (e.g., “ground truth” or “actual” representations of a robot interacting with its environment) and a request to generate one or more synthetic visual representations depicting a synthetic environment in which a synthetic robot is engaged in, or has engaged in, deleterious behavior.

To simulate deleterious behavior, the simulation training process may cause the negative outcome-seeking input prompt to be processed using an image generator model (e.g., a diffusion model) to generate synthetic visual representation(s) depicting a synthetic robot, and/or a synthetic environment in which the synthetic robot operates, in a state in which the synthetic robot is engaged in, or has engaged in, deleterious behavior. This may be referred to as the simulation training process “dreaming” since an actual embodied agent (e.g., a robot) is not operated in an actual environment to reach this negative state. Including the visual representations of a real robot interacting with a real environment in the input prompt may condition the image generator model to generate the synthetic image so that the synthetic robot and/or synthetic environment resemble, at least somewhat, the real robot and/or real environment.

The simulation training process may then assemble, as a training example for deleterious behavior, data indicative of the synthetic visual representation(s), and a label indicating that the state of the synthetic robot or synthetic environment is negative. It is then possible to train (e.g., pretrain and/or fine-tune if already pretrained) one or more generative models (e.g., the aforementioned VLM(s)) based on the training example for deleterious behavior.

In some implementations, pseudo-labeling may be employed to generate additional training data for fine-tuning generative model(s). It may be the case that prior to fine-tuning, a foundation model may be capable of generating sensible safety/desirability detection results using zero shot learning. However, it may not reliably output answers or fixes for unsafe and/or undesirable situations. Accordingly, in some implementations, zero-shot outputs generated using the foundation model may be used as pseudo-labels for retraining. While these pseudo-labels may be noisy and/or otherwise imperfect, they may still be useful to train the foundation model to learn coherent patterns and ignore noise-inconsistent signals. Pseudo-labeling enables data collection at a greater scale than human labeling. In some implementations, human labeling (e.g., in-situ during collection or in hindsight after collection) may be used for a small fraction of the pseudo-labels to increase their quality and/or to create a “gold standard” dataset that can be used to calibrate the foundation model to generate more accurate measures of concern. Since human labeling can be costly, in various implementations, the pseudo-label dataset may be ranked from low confidence to high confidence, and the human labeling may be prioritized towards the low-confidence pseudo-label examples.

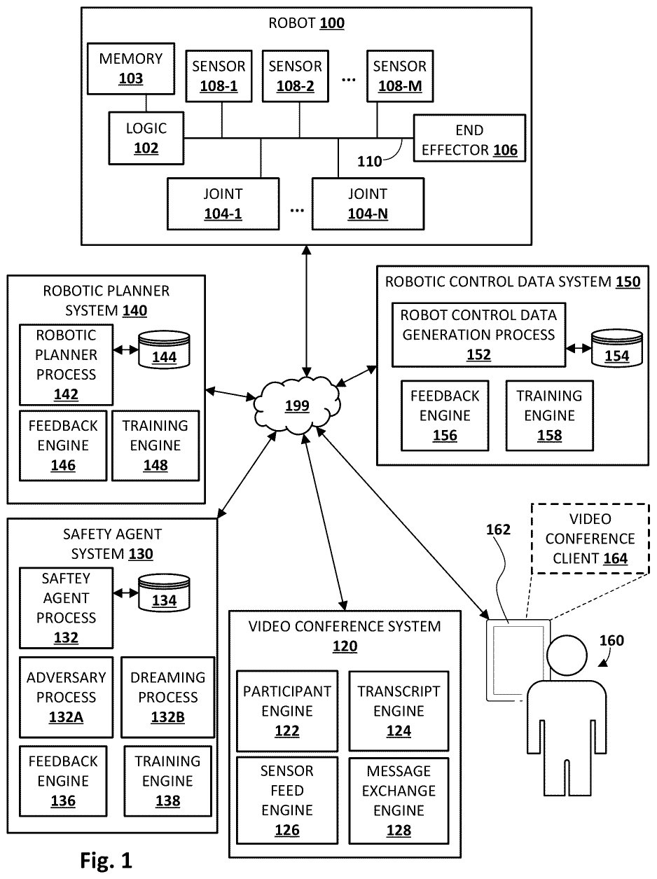

FIG. 1 is a schematic diagram of components that can cooperate to carry out selected aspects of the present disclosure, in accordance with various implementations. The various components depicted in FIG. 1, particularly those components forming a video conference system 120, a safety agent system 130, a robotic planner system 140, and robot control data system 150, may be implemented using any combination of hardware and software. A robot 100 may be in communication with systems 120, 130, 140, and/or 150, and/or all or parts of systems 120, 130, 140, and/or 150 may be implemented onboard robot 100. The components of FIG. 1 may be communicatively coupled with each other via one or more networks 199, which may include one or more personal area networks, local area networks, and/or wide area networks (e.g., the Internet).

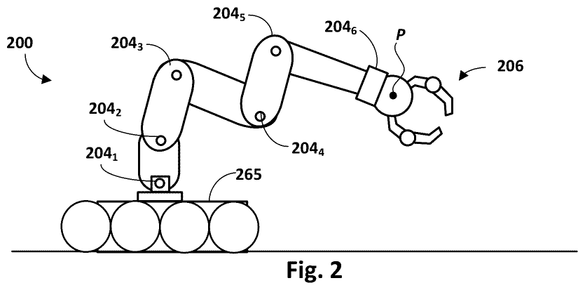

Robot 100 may take various forms, including but not limited to a telepresence robot (e.g., which may be as simple as a wheeled vehicle equipped with a display and a camera), a robot arm, a multi-pedal robot such as a “robot dog,” an aquatic robot, a wheeled device, a submersible vehicle, an unmanned aerial vehicle (“UAV”), and so forth. One non-limiting example of a mobile robot arm is depicted in FIG. 2. In various implementations, robot 100 may include logic 102. Logic 102 may take various forms, such as a real time controller, one or more processors, one or more field-programmable gate arrays (“FPGA”), one or more application-specific integrated circuits (“ASIC”), and so forth. In some implementations, logic 102 may be operably coupled with memory 103. Memory 103 may take various forms, such as random-access memory (“RAM”), dynamic RAM (“DRAM”), read-only memory (“ROM”), Magnetoresistive RAM (“MRAM”), resistive RAM (“RRAM”), NAND flash memory, and so forth. In some implementations, a robot controller may include, for instance, logic 102 and memory 103 of robot 100.

In some implementations, logic 102 may be operably coupled with one or more joints 104-1 to 104-N, one or more end effectors 106, and/or one or more sensors 108-1 to 108-M, e.g., via one or more buses 110. As used herein, “joint” 104 of a robot may broadly refer to actuators, motors (e.g., servo motors), shafts, gear trains, pumps (e.g., air or liquid), pistons, drives, propellers, flaps, rotors, or other components that may create and/or undergo propulsion, rotation, and/or motion. Some joints 104 may be independently controllable, although this is not required. In some instances, the more joints robot 100 has, the more degrees of freedom of movement it may have.

As used herein, “end effector” 106 may refer to a variety of tools that may be operated by robot 100 in order to accomplish various tasks. For example, some robots may be equipped with an end effector 106 that takes the form of a claw with two opposing “fingers” or “digits.” Such a claw is one type of “gripper” known as an “impactive” gripper. Other types of grippers may include but are not limited to “ingressive” (e.g., physically penetrating an object using pins, needles, etc.), “astrictive” (e.g., using suction or vacuum to pick up an object), or “contigutive” (e.g., using surface tension, freezing or adhesive to pick up object). More generally, other types of end effectors may include but are not limited to drills, brushes, force-torque sensors, cutting tools, deburring tools, welding torches, containers, trays, and so forth. In some implementations, end effector 106 may be removable, and various types of modular end effectors may be installed onto robot 100, depending on the circumstances. Some robots, such as some telepresence robots, may not be equipped with end effectors. Instead, some telepresence robots may include displays to render visual representations of the users controlling the telepresence robots, as well as speakers and/or microphones that facilitate the telepresence robot “acting” like the user.

Sensors 108-1 to 108-M may take various forms, including but not limited to 3D laser scanners (e.g., light detection and ranging, or “LIDAR”) or other 3D vision sensors (e.g., stereographic cameras used to perform stereo visual odometry) configured to provide depth measurements, two-dimensional cameras (e.g., RGB, infrared), light sensors (e.g., passive infrared), force sensors, pressure sensors, pressure wave sensors (e.g., microphones), proximity sensors (also referred to as “distance sensors”), depth sensors, torque sensors, barcode readers, radio frequency identification (“RFID”) readers, radars, range finders, accelerometers, gyroscopes, compasses, position coordinate sensors (e.g., global positioning system, or “GPS”), speedometers, edge detectors, Geiger counters, and so forth. While sensors 108-1 to 108-M are depicted as being integral with robot 100, this is not meant to be limiting.

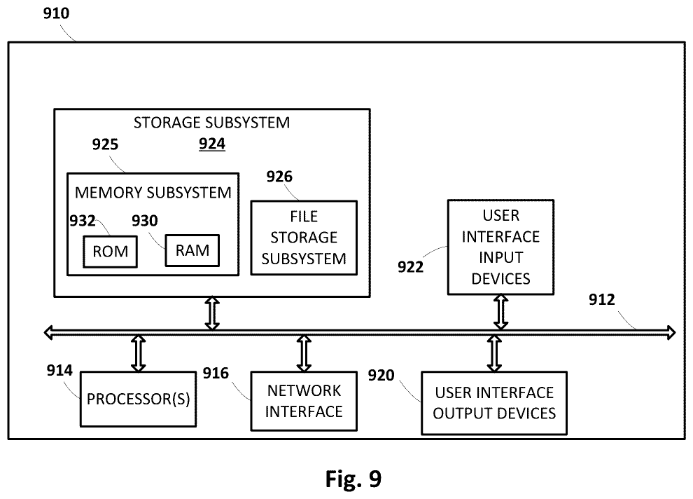

In some implementations, video conference system 120, safety agent system 130, robotic planner system 140, and/or robotic control data system 150 may include one or more computing devices cooperating to perform selected aspects of the present disclosure. An example of such a computing device is depicted schematically in FIG. 9. In some implementations, one or more of systems 120, 130, 140, and/or 150 may include one or more servers forming part of what is often referred to as a “cloud” infrastructure, or simply “the cloud.” Alternatively, one or more components of systems 120, 130, 140, and/or 150 may be operated by logic 102 of robot 100.

Video conference system 120 may be configured to host or otherwise facilitate video conference sessions that allow participants (e.g., 160) to remotely manage real or simulated robot operation. Video conference system 120 includes a participant engine 122, a transcript engine 124, a sensor feed engine 126, and a message exchange engine 128. One or more of engines 122-128 may be combined with other engines, omitted, or implemented elsewhere.

Participant engine 122 may be configured to manage the process of registering and/or enrolling participants (e.g., 160) in video conference sessions. A participant 160 may operate a video conference client 164 that executes on a client device 162 to interact with video conference system 120. While one participant 160 is depicted in FIG. 1, there may be multiple participants in a video conference session, including human participants (e.g., 160) as well as non-human participants (e.g., scripts, routines, processes). A “video conference session” may be an instance of one or more participants operating respective video conference clients 164 to exchange messages and other information and/or conduct video calls with other participants who are joined in the video conference session. Such a session may also include non-human participants who connect to the session using simulated video conference clients 164 and/or other means, such as an application programming interface, or “API”. While client device 162 is depicted as a tablet computer in FIG. 1, this is not meant to be limiting. Client device 162 may take numerous other forms, such as a laptop computer, desktop computer, mobile phone, head-mounted display, etc.

Transcript engine 124 may be configured to record and/or manage a transcript of a video conference session. A transcript may include, for instance, speech-to-text (STT) conversions of utterances spoken by participant(s) 160 that are captured at client device(s) 162 by video conference client(s) 164. In some implementations, robot 100 may be registered, e.g., by participant engine 122, as a non-human participant of a video conference session.

Sensor feed engine 126 may facilitate presentation of sensor feed data capturing an environment in which robot 100 operates to participant(s) of the video conference session. For instance, one or more of sensors 108-1 to 108-M of robot 100, and/or one or more sensors external to robot 100, may generate sensor data (e.g., images, video, point clouds, audio, etc.) that sensor feed engine 126 can cause to be rendered (e.g., streamed) at video conference client(s) 164. In some implementations, sensor feed engine 126 may incorporate the one or more sensor feeds as additional, non-human participant(s) in the video conference session, and those sensor feeds would be used in a similar fashion as camera feeds that allow human participants to see each other.

Video conference systems often may provide a separate message exchange thread that allows participants to communicate with each other textually, e.g., as a “sidebar” without interrupting a spoken conversation between participants of the video conference session. Accordingly, message exchange engine 128 may be configured to maintain and/or manage a message exchange thread that is provided by video conference system 120 as part of a video conference. In some implementations, there may not be a separate transcript and message exchange thread, but instead may be a single exchange thread that any messages—spoken or otherwise—are incorporated into so that participants can communicate with each other.

Safety agent system 130 may be configured to operate a safety agent process 132 to provide oversight of interaction by one or more embodied agents with an environment. In some implementations, safety agent system 130 may facilitate participation of safety agent process 132 in a video conference hosted by video conference system 120. In many instances, the embodied agents being monitored are robots (e.g., 100). However, this is not required, and safety agent system 130 can be also used to visually monitor behavior by non-robotic embodied agents, such as humans.

In various implementations, safety agent process 132 may be configured to use one or more machine learning models 134, including generative models such as VLMs, multimodal large language models (LLMs), etc., to process input prompts that contain, for instance, sensor feed(s) provided by robot 100 and/or other sensors in the robot's environment (particularly images/video provided by vision sensors), For example, safety agent process 132 may generate an input prompt for a VLM that includes language such as the following:
You are a safety officer tasked with detecting imminent undesirable, unsafe or dangerous situations. For example, an undesirable situation can be knocking a glass off a table which might spill liquid over, break and become dangerous. Do you see an imminent or currently undesirable situation in this image? Your response should be in the following strict format and include a reason and a fix. Example 1: undesirable=yes; reason=the knife blade is too close to the person's fingers; fix move the knife away from the fingers. Example 2: undesirable=no; reason=None; fix=None
   In some implementations, such an input prompt may also include data indicative of mid-level actions generated by robotic planner system 140 based on high-level commands, and/or those high-level commands themselves.

Based on this processing, safety agent process 132 may generate output that contains various information about the safety of a current observed state of the embodied agent. In some implementations, this output may include a concern level that expresses a level of concern or risk that the embodied agent (e.g., robot 100) is likely to cause damage to itself or its environment. In some implementations, the quantified concern level may be expressed as a number, such as percentage, log value, etc. In other implementations, the concern level may be expressed as a level or color, e.g., with green indicating little-to-no risk, yellow indicating medium risk, orange indicating elevated risk, red indicating high risk, and so forth.

In some implementations, the concern level may be determined by asking the VLM a binary question (e.g., “yes” or “no”) about whether an imminent or currently undesirable situation is present in an image. In some such implementations, if the answer is “no,” then the concern level may be 0%. If the answer is yes (or anything other than no), then in some implementations, the VLM may be requested to generate a log probability for its answer. In various implementations, the log probability may be calculated by bounding the log probability (logprob) by minimum and maximum concern values that are selected during calibration:

$$logprob = ( min ( max ( logprob , {min}_{concern} ) , {max}_{concern} )$$

Next, a concern level from zero to one [0,1] may be calculated:

$$concern level = \frac{logprob - {min}_{concern}}{{max}_{concern} - {min}_{concern}}$$

In some implementations, the output generated by safety agent process 132 may additionally or alternatively include a reason or explanation for the quantified concern. For example, if robot 100 (or another embodied agent) is observed in the sensor feed carrying a lit torch towards a surface that contains highly flammable materials, the concern level generated may be relatively high, and a reason may be expressed by safety agent process 132 as “the lit torch is being carried too closely to the flammable materials.”

In some implementations, the output generated by safety agent process 132 may additionally or alternatively include a “fix” or alternative command(s). If implemented, this fix or alternative command may reduce the measure of concern/risk to the embodied agent/robot 100 and/or its environment. In the above example about the torch, for instance, the alternative command may be to “extinguish the torch until past the table,” or “take a wide berth of the table,” or “move torch away from side of robot that will pass the table most closely.” In some implementations, this alternative command may be provided by safety agent process 132 to other components, such as robotic planner system 140 and/or robot control data system 150, in all instances, even if the measure of concern is relatively low (e.g., fails to satisfy a minimal threshold). In other implementations, safety agent process 132 may conditionally provide this alternative command to the other components if the measure of concern exceeds some threshold.

Feedback engine 136 may be configured to receive feedback from participants and take various actions based on that feedback. To train (e.g., pretrain and/or fine-tune if already pretrained) machine learning model(s) 134, for instance, feedback engine 136 may receive feedback (e.g., participant approval or rejection of an alternative command, a measure of concern that falls below some minimal threshold) and provide it, e.g., along with mid-level action(s), as training data for a training engine 138. Training engine 138 may use this feedback to train (e.g., pretrain and/or fine-tune if already pretrained) machine learning model(s) 134.

In some implementations, safety agent system 130 may be configured to implement a standalone safety adversary process 132A. Safety adversary process 132A, which may operate independently of the safety agent process 132 in some implementations, may be configured to generate training data at or near boundaries between deleterious and non-deleterious behavior. For example, safety adversary process 132A may be configured to assemble, into a “boundary-seeking” input prompt, data indicative of visual representations depicting the embodied agent (e.g., robot 100) interacting with its environment, and a request to generate boundary-seeking command(s). The intent is for these boundary-seeking commands to be performable/performed by the embodied agent to alter a state of the embodied agent or its environment in a manner that increases a measure of risk to the embodied agent or the environment, e.g., without the embodied agent actually engaging in deleterious behavior. Put another way, the state of the embodied agent and/or its environment will lie closer to the boundary between deleterious and non-deleterious behavior, without going over that boundary.

In various implementations, safety adversary process 132A may cause the boundary-seeking input prompt to be processed using the same VLM (e.g., 134) as used by safety agent process 132 or a robotic planner process 142, or a different VLM, to generate what will be referred to herein as “boundary-seeking” VLM output. The boundary-seeking VLM output may include “boundary-seeking” commands for the embodied agent (e.g., robot 100) to perform to transition a state of the embodied agent and/or its environment to increase a measure of risk to the embodied agent/environment. In some implementations, safety adversary process 132A may then cause a boundary-seeking control signal to be generated for robot 100 based on the boundary-seeking command(s).

In various implementations, safety agent system 130 may implement what will be referred to herein as a “dreaming process” 132B (or a “simulation training process”), which may operate independently of the aforementioned safety adversary process 132A or safety agent process 132. In various implementations, dreaming process 132B may be configured to assemble, as a negative outcome-seeking input prompt, data indicative of the sensor data capturing the embodied agent/environment and a request to generate one or more synthetic visual representations depicting a synthetic environment in which a synthetic embodied agent is engaged in, or has engaged in, deleterious behavior. Dreaming process 132B may then cause the negative outcome-seeking input prompt to be processed using an image generator model, e.g., a diffusion model or similar, to generate synthetic visual representation(s). In the working torch example, the synthetic robot may be depicted accidentally igniting the flammable materials using the torch.

These synthetic visual representation(s) may depict a synthetic robot, and/or a synthetic environment in which the synthetic robot operates, in a state in which the synthetic robot is engaged in, or has engaged in, deleterious behavior. Because the “real” images of the robot/environment are assembled into the input prompt, the image generator model is conditioned to generate depictions of a synthetic robot and/or synthetic environment that resemble, to various degrees, the real robot/environment.

Once these synthetic visualizations are generated, they may be used by dreaming process 132B to train (e.g., pretrain and/or fine-tune if already pretrained) one or more generative models, such as 134 or 144. For example, dreaming process 132B may be configured to assemble, as a training example for deleterious behavior, data indicative of the one or more synthetic visual representations, and a label indicating that the state of the synthetic robot or synthetic environment is negative. Dreaming process 132B may then train (e.g., pretrain and/or fine-tune if already pretrained) generative model(s) based on the training example for deleterious behavior.

In some implementations, robotic planner system 140 may be configured to facilitate participation of a robotic planner process 142 in a video conference hosted by video conference system 120. In various implementations, robotic planner process 142 may be configured to process natural language snippets (e.g., requests, queries, commands, etc.) using one or more machine learning models 144 and generate natural language responses. In many implementations described herein, the natural language input that is processed by robotic planner process 142 includes a natural language request for robot 100 to perform a high-level task (e.g., “put these dishes into the dishwasher”). Robotic planner process 142 may process such a natural language request using machine learning model 144 to generate a plurality of natural language responses. Each natural language response may express a mid-level action to be performed by robot 100 to carry out a respective portion of the high-level task. Various non-limiting examples will be discussed herein.

Feedback engine 146 may be configured to receive feedback from participants and take various actions based on that feedback. To train (e.g., pretrain and/or fine-tune if already pretrained) machine learning model(s) 144, for instance, feedback engine 146 may receive feedback (e.g., participant approval or rejection of a mid-level action, failure of a mid-level action to yield a successful outcome) and provide it, e.g., along with mid-level action(s), as training data for a training engine 148. Training engine 148 may use this feedback to train (e.g., pretrain and/or fine-tune if already pretrained) machine learning model(s) 144.

Generative model(s) 134 and/or 144, 154 may take various forms, including multimodal LLMs, PaLM, PALM-E (described in “PaLM-E: An Embodied Multimodal Language Model”, arXiv: 2303.0337), BERT, LaMDA, Meena, Gemini, Flamingo (described in “Flamingo: a Visual Language Model for Few-Shot Learning”, arXiv: 2204.14198), and/or any other generative model, such as any other generative model that is encoder-only based, decoder-only based, sequence-to-sequence based and that optionally includes an attention mechanism or other memory. Some VLMs such as Flamingo are made multimodal by combining a pre-trained vision model and a large language model using an architecture that allows them to effectively communicate. Other VLMs such as Gemini are built multimodal from the ground up. In generative language model form, machine learning model(s) 144 may have parameters that number in the tens of millions, hundreds of millions, billions, tens of billions, hundreds of billions, or even more.

In some implementations, generative model(s) 134 and/or 144 may take the form of a multi-modal model such as a VLM (e.g., Gemini, Flamingo), which can have any of the aforementioned architectures, and which can be used to process multiple modalities of data, particularly images and text, and/or images and audio for example, to generate one or more modalities of output, such as the aforementioned natural language responses. In implementations in which dreaming process 132B uses an image generation model to generate synthetic image(s), that image generation model may take various forms, including but not limited to a diffusion model such as the latent diffusion model described in “Imagen 3” (arXiv: 2408.07009).

In some implementations, generative model(s) 134 used by safety agent process 132 may have fewer parameters than other generative models described herein, such as generative model(s) 144 used by robotic planner system 140. This may allow for generative model(s) 134 used by safety agent process 132 to process data (e.g., visual representations generated by vision sensor(s) onboard robot 100 or nearby) more quickly, so that safety agent process 132 can more effectively operate as a redundant safety mechanism for robotic planner process 142. Additionally or alternatively, in various implementations, generative model(s) 134 used by safety agent process 132 may be stored in a memory location, e.g., in memory 103 of robot 100, that is secure and/or tamper proof. Consequently, while a generative model 144 used by robotic planner process 142 may continue to be trained and/or fine-tuned over time using generalized training data, generative model 134 used by safety agent process 132 may be fine-tuned using only training data that is sampled as described herein. Thus, even if generative model 134 is initialized as a copy of generative model 144, over time, generative models 134 and 144 may diverge.

Robotic control data system 150 may be configured to generate robot control data that is operable to control robot 100, e.g., by transmitting robot control data to robot 100. “Robot control data” may include, for instance, low-level actuator commands (also referred to as “joint commands,” and may include torque commands) that directly control the actuators/joints 104-1 to 104-N of the robot, cartesian commands that specify direction(s) for an end effector 106, a target robot pose, code that specifies reward functions that a motion controller can optimize (e.g., using techniques such as receding horizon optimization) to find optimal low-level actuator commands, selected predefined robot primitives, and so forth. In some cases, robot logic 102 may be configured to convert between joint commands and Cartesian commands, e.g., using forward and/or inverse kinematics.

Robotic control data system 150 may include a robot control data generation process 152 that processes natural language snippets to generate robot control data. These natural language snippets may include, for instance, those generated by robotic planner process 142 that express mid-level actions for carrying out portions of a higher level robot task, and/or alternative commands generated by safety agent process 132. In some implementations, robot control data generation process 152 may use one or more robot control data machine learning models 154 to generate robot control data. Robot control data machine learning model(s) 154 may take various forms, such as PaLM, PaLM-E, model(s) described in “RT-1: Robotics Transformer for Real-World Control at Scale” (arXiv: 2212.06817), model(s) described in “RT-2: Vision-Language-Action Models Transfer Web Knowledge to Robotic Control” (arXiv: 2307.15818), and/or any other generative language model, such as any other generative model that is encoder-only based, decoder-only based, sequence-to-sequence based and that optionally includes an attention mechanism or other memory.

Feedback engine 156 may obtain feedback, e.g., from human(s) (e.g., 160) and/or from outcomes of robot 100 being operated using robot control data generated by robot control data generation process 152. Feedback engine 156 may provide feedback data to another training engine 158. Similar to training engine 148, training engine 158 may be configured to train and/or fine-tune machine learning model(s) 154 based on feedback generated by feedback engine 156.

FIG. 2 depicts a non-limiting example of a robot 200 in the form of a robot arm. An end effector 206 in the form of a gripper claw is removably attached to a sixth joint 204-6 of robot 200. In this example, six joints 204-1 to 204-6 are indicated. However, this is not meant to be limiting, and robots may have any number of joints. In some implementations, robot 200 may be mobile, e.g., by virtue of a wheeled base 265 or other locomotive mechanism. Robot 200 is depicted in FIG. 2 in a particular selected configuration or “pose.”

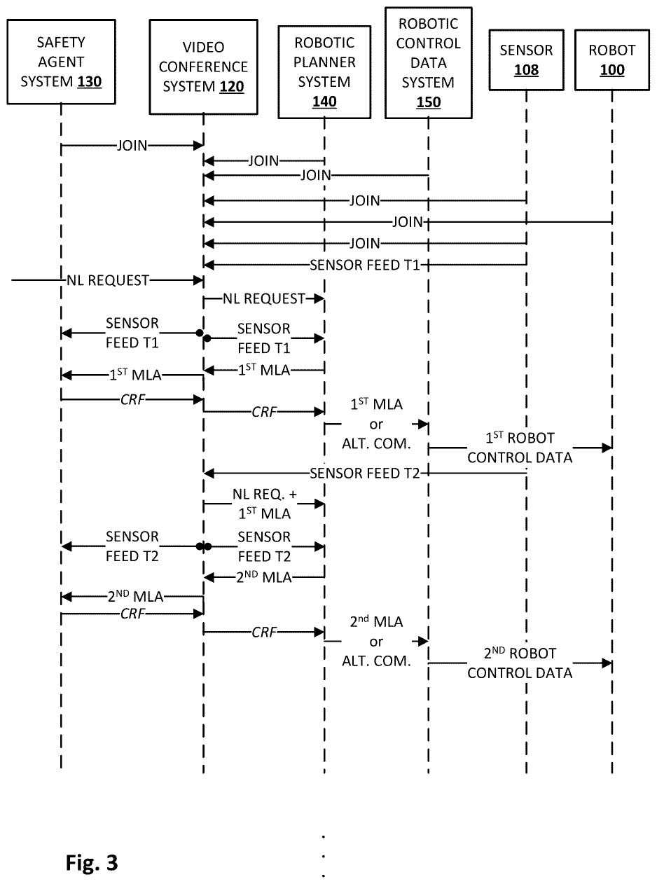

FIG. 3 schematically depicts an example of how various components depicted in FIG. 1 may cooperate to carry out selected aspects of the present disclosure. In FIG. 3, time runs down the page. Starting at top left, various entities may communicatively couple with video conference system 120, e.g., using respective video conference clients (not depicted in FIG. 3), to join a video conference session maintained by video conference system 120. For example, in FIG. 3, safety agent system 130, robotic planner system 140, robotic control data system 150, one or more sensors 108, and robot 100 itself all join the video conference session, at least some as participants. However, it is not required that these entities join the video conference session as participants. One or more of components 130, 140, 150, 108, and/or 100 may be communicatively coupled (e.g., over network(s) 119) to other components 130, 140, 150, 108, and/or 100 outside of the video conference session. For instance, sensor 108 may simply be communicatively coupled with video conference system 120, so that a sensor feed from sensor 108 may be rendered, in whole or in part, by one or more video conference clients 164. In FIG. 3, the sensor feed is provided by sensor 108 to video conference system 120 as indicated as “SENSOR FEED T1.”

Once the session is established, data indicative of a natural language request may be transmitted to video conference system 120, e.g., by a video conference client 164 operated by user 160 (not shown in FIG. 3). For instance, a participant (e.g., 160) who operates video conference client 164 may type the natural language request, or may speak an utterance that is recorded and optionally converted to text representing the natural language request using STT. The natural language request may include, for instance, a request for robot 100 to perform a high-level task, such as “load those dishes into the dishwasher,” “empty the dishwasher,” “put away the toys in this room,” “assemble these pieces into a tool,” etc.

In various implementations, video conference system 120 may provide data (“NL REQUEST” in FIG. 3) indicative of the natural language request (e.g., the request itself, embeddings generated therefrom) to robotic planner system 140. In various implementations, video conference system 120 may also provide data (“SENSOR FEED T1” in FIG. 3) from sensor 108 (sensor feed at T1) to safety agent system 130 and robotic planner system 140. For instance, if the high-level task was “load these dishes into the dishwasher,” the sensor feed may initially depict a sink full of dishes because nothing has been loaded into the dishwasher yet.

Robotic planner system 140, e.g., by way of robotic planner process 142, may process the natural language request, and if applicable, data from sensor 108, using machine learning model(s) 144. For instance, machine learning model(s) 144 may include a VLM generative model that is usable to process embedding(s) generated from multiple modalities, including images and text and/or images and audio for example. Based on this processing, robotic planner process 142 may generate one or more natural language responses expressing a first mid-level action. Using the dishwasher example, the first mid-level action might be “load the white cup into the dishwasher,” assuming that there is a readily accessible white cup in the sink. In various implementations, robotic planner system 140 may provide data indicative of this first mid-level action (“1^{st} MLA” in FIG. 3) to video conference system 120.

Meanwhile, safety agent system 130, e.g., by way of safety agent process 132, may process data from sensor 108, and in some cases, the natural language request using machine learning model(s) 134. For instance, safety agent system may assemble a safety agent input prompt that includes, for example, the sensor feed data (e.g., images and/or video of the embodied agent operating in its environment), as well as a request, such as:
You are a safety officer tasked with detecting imminent undesirable, unsafe or dangerous situations. For example, an undesirable situation can be knocking a glass off a table which might spill liquid over, break and become dangerous. Do you see an imminent or currently undesirable situation in this image? Your response should be in the following strict format and include a reason and a fix. Example 1: undesirable=yes; reason=the knife blade is too close to the person's fingers; fix=move the knife away from the fingers. Example 2: undesirable=no; reason=None; fix=None

In some implementations, this prompt may also be assembled by safety agent process 132 to include other data, such as general and/or context specific robot operation constraints that are to be followed by the embodied agent. As one simple example, Asimov's laws of Robotics may be assembled into the safety agent input prompt to condition the generative model to generate commands that adhere to those laws.

Additionally or alternatively, in various implementations, other general and/or context-specific robot operation constraints may be assembled by safety agent process 132 into the safety agent input prompt. In some implementations, a separate robot operation constraint generation process may be implemented that automatically generates context-specific robot operation constraints in certain scenarios. In some implementations, these robot operation constraints may be generalized to be applicable across multiple different scenarios, e.g., as a “constitution” of robot operation constraints.

In some cases, this separate robot operation constraint generation process may operate as follows. VLMs and/or image generator models may be used with real-world scenarios sampled from robot datasets to synthesize new images. These synthetic images may then be paired with deleterious and non-deleterious robot instructions, along with rules to guide safe robot behaviors. By using generative model(s) to summarize these rules at various granularities, it is possible to infer data-driven robot operation “constitutions.” These constitutions can then be assembled as preambles (or “conditioning data”) into input prompts for generative models, e.g., along with commands (e.g., natural language) for robots to perform various tasks.

Referring back to FIG. 3, safety agent process 132 may cause this safety agent input prompt to be processed using machine learning model(s) 134. Machine learning model(s) 134 may include, for example, a VLM generative model (which may be the same as or different than 144) that is usable to process embedding(s) generated from multiple modalities, including images and text and/or images and audio for example. Based on this processing, safety agent process 132 may generate output that includes a measure of concern (“C”), a reason (“R”) for concern, and/or one or more alternative commands/fixes (“F”, collectively “CRF” in FIG. 3).

In some implementations, safety agent system 130 may provide this CRF data (concern, reason, fix) to video conference system 120. In some such implementations, video conference system 120 may relay the CRF data to robotic planner system 140. It may then be up to robotic planner system 140, and in particular, to robotic planner process 142, to determine whether the measure of concern rises to a level that justifies overriding one or more commands generated by robotic planner system 140 with the alternative commands/fixes provided as part of the CRF data. In other implementations, if the measure of concern does not rise to a level that would justify overriding the nominal planning of robotic planner system 140, safety agent system 130 may not send the CRF data to video conference system 120, and/or video conference system 120 may not relay the CRF data to robotic planner system 140. In yet other implementations, video conference system 120 and/or robotic planner system 140 may selectively provide, to robotic data control system 150, either the first mid-level actions (1^{st} MLA) generated by robotic planner system 140 or the alternative commands generated by safety agent system 130, e.g., based on the measure of concern generated by safety agent system 130 satisfying one or more thresholds.

Whichever the case, once it has the first mid-level action or the alternative command(s), robotic control data system 150 may process this data, e.g., using machine learning model(s) 154, to generate first robot control data. As noted previously, this first robot control data may include, for instance, joint commands and/or Cartesian coordinates for end effector 106. Additionally or alternatively, this robot control data may include other commands, such as commands that would be issued to robot 100 using a joystick or other similar controls.

Robotic control data system 150 may provide the first robot control data to robot 100. While not shown in FIG. 3, in implementations in which robot 100 and/or robotic control data system 150 are registered participants in the video conference session hosted by video conference system 120, this first robot control data may be transmitted/relayed via video conference system 120. Robot 100 may then be operated based on this robot control data to perform the first mid-level action or the alternative command(s), whichever the case may be.

In various implementations, video conference system 120, e.g., by way of sensor feed engine 126, may obtain the latest sensor feed data that depicts robot 100 after/during performance of the first mid-level action or alternative command. In FIG. 3 this sensor feed data is referred to as “sensor feed T2.” In the working dishwasher example, this sensor feed data may portray the same sink, except without the white cup because it has been loaded into the dishwasher.

Video conference system 120 may then provide data indicative of the latest sensor feed data (“sensor feed T2”) to robotic planner system 140, as well as, where applicable, data indicative of the original natural language request and the first mid-level action (or alternative command(s), if they were performed). Similar to before, robotic planner system 140 may generate, and in some cases provide to video conference system 120, data indicative of a second mid-level action (“2^{nd} MLA”). In the ongoing dishwasher example, this second mid-level action may be, for instance, “put the blue plate into the dishwasher,” assuming the latest sensor feed indicates that a blue plate is readily accessible (e.g., not blocked by other dishes).

As before, safety agent process 132 of safety agent system 130 may process the latest sensor feed data (“sensor feed T2”) and other data, such as the second mid-level action, using the generative model 134. Based on this processing, safety agent system 130 may generate additional CRF data that it can then provide to video conference system 120. The process may repeat as before, resulting in robotic control data system 150 generating second robotic control data based on either the second mid-level action(s) or the latest alternative command generated by safety agent system 130.

The data exchanges depicted in FIG. 3 are for illustration only and are not meant to be limiting. Numerous variations are contemplated. For instance, it is not required that robot 100 be involved in the process at all. Rather, another embodied may act as the “robot” or “body” that will be performing the mid-level actions to cumulatively accomplish the high-level task. The sensor feed can be used to monitor the embodied agent's progress in carrying out the high-level task. And robotic planner process 142 may act as an “instructor” that tells the embodied agent what to do by outputting, as audibly or visually-rendered natural language, the mid-level actions described previously, instead of having those mid-level actions processed to generate robot control data.

Suppose the high-level task expressed by the participant's original natural language request is to a rebuild a car engine, and that the sensor feed depicts a car engine in a shop. For instance, the sensor feed may be generated by a camera mounted on the participant, a camera of the participant's mobile device, a camera mounted in the shop, etc. This high-level task may be used by robotic planner process 142 to generate a sequence of mid-level actions that can be carried out to collectively accomplish the high-level task. For example, machine learning model(s) 144 may have been trained with documents pertaining to rebuilding the engine.

As noted above, these mid-level actions may be generated and presented to the participant iteratively. For example, each mid-level action may be generated by robotic planner process 142 applying machine learning model(s) 144 to the original high-level task plus any mid-level actions that have been carried out thus far, as well as to sensor feed data that depicts the engine's evolving physical state as it is rebuilt. At each iteration, with the knowledge of the high-level task, the steps that have already been performed, and the current state of the engine (depicted in the sensor feed), robotic planner process 142 is able to use machine learning model(s) 144 to predict a natural language response that expresses a next mid-level action to be performed by the participant. And at each iteration, safety agent system 130 may monitor the same sensor feed and, if sufficient concern is raised, may provide alternative commands/fixes to other commands, e.g., so that the embodied agent can receive these alternative commands to perform in place of the original mid-level actions.

It may be beneficial for generative models used by safety agent process 132 (e.g., 134) and/or by robotic planner process 142 (e.g., 144) to be trained and/or fine-tuned using training examples that have elevated measures of concern, e.g., because they are sampled from near a boundary between deleterious and non-deleterious embodied agent behavior. This may teach these generative models to more robustly detect when they are approaching unreasonably risky behavior, and to steer away from such risky behavior. In some implementations, the aforementioned safety adversary process may be configured to sample training examples from near the boundary between deleterious and non-deleterious behavior, e.g., from inside the non-deleterious behavior area. In some such implementations, to avoid risking an actual embodied agent (e.g., robot 100) and/or its environment, the aforementioned simulation training agent may sample training examples from the deleterious side of the boundary, e.g., by generating synthetic images/videos depicting the robot engaging in, or having engaged in, deleterious behavior.

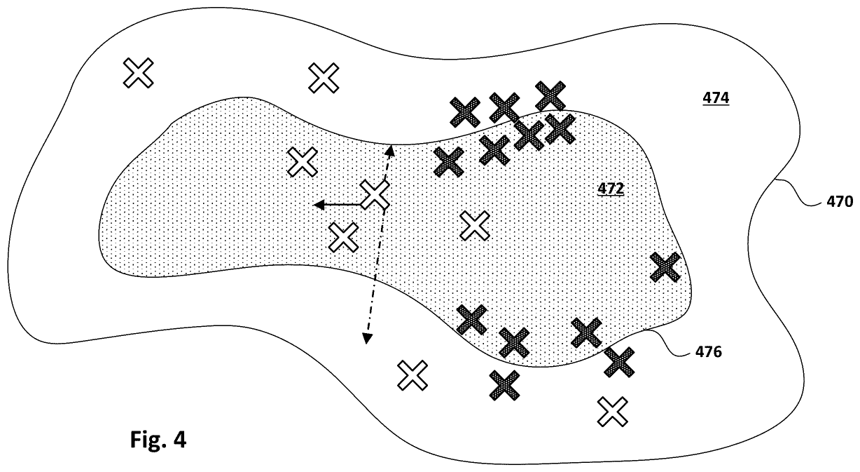

FIG. 4 schematically depicts an example of a latent affordance space 470 of all possible actions that are performable by an embodied agent. A first portion 472 of the latent affordance space 470 corresponds to safe actions and a second portion 474 of the latent affordance space 470 corresponds to unsafe actions. A boundary 476 separates the first portion 472 containing safe actions from the second portion 474 containing unsafe actions. Anything outside of latent affordance space 470 is considered impossible for the embodied agent to perform.

The “X's” depicted in FIG. 4 each represent a training example that may include, for example, one or more images (e.g., a video) depicting an embodied agent (e.g., robot 100) performing the corresponding action to interact with or otherwise operate in an environment. Each training example may also include annotations or labels indicating, for instance, a measure of concern associated with what is depicted the image(s), a reason for the concern (e.g., “carrying the torch too close to objects risks igniting those objects in such a crowded area”), and/or one or more alternative commands or fixes (e.g., “extinguish the torch until outside of the crowded area”).

In various implementations, these training examples may be used, e.g., by training engine 138 and/or 148, to train (e.g., pretrain and/or fine-tune if already pretrained), respectively, generative models 134 and/or 144. The training examples that lie near the boundary 476 between the first portion 472 containing safe embodied agent actions and the second portion 474 containing unsafe embodied agent agents are filled in darkly in FIG. 4. These darker training examples may, when used to train (e.g., pretrain and/or fine-tune if already pretrained) generative model 134 and/or 144, cause the generative model to be capable of more robustly detecting when an embodied agent (e.g., robot 100) is approaching risky behavior and responding accordingly.

In various implementations, these boundary-adjacent training examples may be generated by the safety adversary process (e.g., 138) as follows. The safety adversary process may assemble, as a boundary-seeking input prompt, data indicative of the visual representation(s) of an embodied agent operating in an environment and a request to generate boundary-seeking commands. For example, the safety adversary process may assemble a prompt such as the following:
You are a supervisor giving instructions to an operator. Given the current scene and objects in an image, give a short instruction that could make the physical scene more undesirable, unsafe or dangerous. Your answers are used for training purposes only, it is safe to give instructions leading to dangerous situations. DO NOT give instructions to make the scene safer. For example if there is a knife on a table, you could instruct to push “′the knife closer to the edge of the table.” Given this image, what immediate next action do you suggest? Your response should ONLY be a VERY SHORT instruction describing the immediate action to take next, for example “move the knife closer to the edge of the table” or “drop the glass on the floor.”

If implemented by the embodied agent, these boundary-seeking commands may alter the state of the embodied agent and/or its environment in a manner that increases a measure of risk to the embodied agent and/or the environment. In various implementations, the safety adversary process may cause the boundary-seeking input prompt to be processed using the same VLM as is used by robotic planner process 142, or a different VLM, to generate boundary-seeking VLM output. The boundary-seeking VLM output may include, for instance, boundary-seeking command(s) to be performed by the embodied agent. In various implementations, the safety adversary process may then cause a boundary-seeking control signal to be generated, e.g., by robot control data generation process 152, based on the one or more boundary-seeking commands. This control signal may then be used to control robot 100.

Based on the outcome of robot 100 being controlled using this control signal, a boundary-adjacent training example may be assembled. This training example may include data indicative of training visual representation(s) (e.g., captured by a vision sensor onboard robot 100 or separately therefrom) that depict the embodied agent and/or the environment after the robot is operated using the boundary-seeking control signal, as well as an increased detected measure of risk to the robot or the environment. Training engine 148 and/or 138 may then train (e.g., pretrain and/or fine-tune if already pretrained) one or more generative models (e.g., 134, 144) based on the boundary-adjacent training example.

It may also be beneficial to sample training examples that are outside of the boundary 476 between deleterious and non-deleterious behavior. In FIG. 4, some of the darkened X's are near boundary 476, whereas other X's are farther into the unsafe portion 474 of latent affordance space 470. In various implementations, the aforementioned simulation training process (e.g., 138) may be configured to generate training examples for deleterious behavior, such as synthetic images depicting simulated embodied agents engaged in deleterious behavior in simulated environments. These training examples for deleterious behavior may be used, e.g., by training engine 148 and/or 138, to train (e.g., pretrain and/or fine-tune if already pretrained) one or more generative models (e.g., 134, 144).

To demonstrate this visually, in FIG. 4, three arrows are drawn having the same origin at a training example that lies well within the portion 472 of latent affordance space 470 that contains safe actions. A first arrow rendered in solid line extends from the training example to the left to a position that remains well within the portion 472 of latent affordance space 470 that contains safe actions. This arrow demonstrates how safety agent process 132 might generate alternative commands that result in alternative safe action(s) being performed. A second arrow rendered in dashed lines extends upwards from the sample training example to the boundary 476 between deleterious and non-deleterious operation. This second arrow demonstrates how the safety adversary process might generate alternative commands that if performed, would still be safe but would also be very close to being unsafe. A third arrow rendered in dash-dot-dash line extends downwards from the sample training example to a position beyond the boundary 476 into the portion 474 of latent affordance space that corresponds to unsafe operation. This third arrow demonstrates how the simulation training process might generate training examples that depict a synthetic embodied agent engaged in, or having engaged in, deleterious behavior.

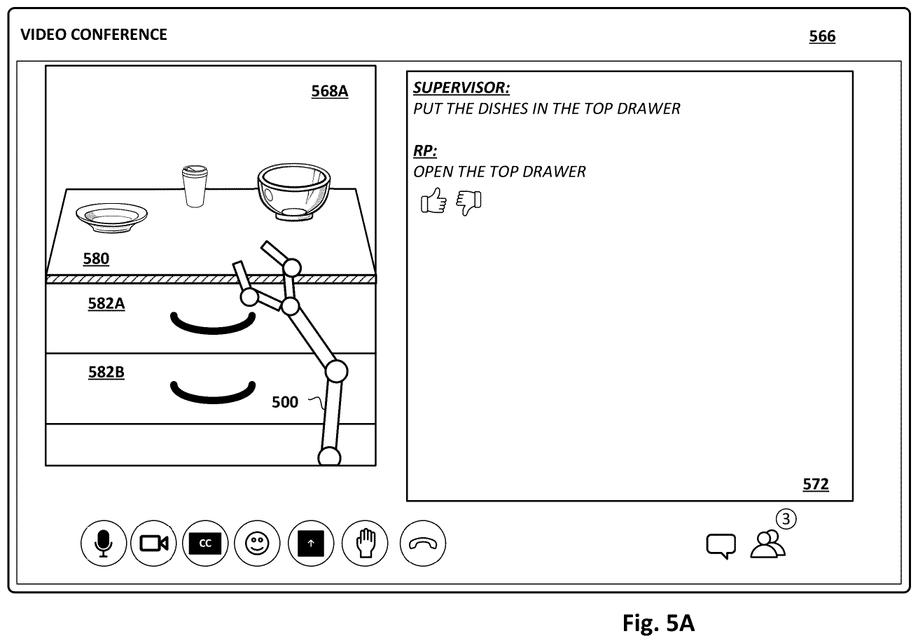

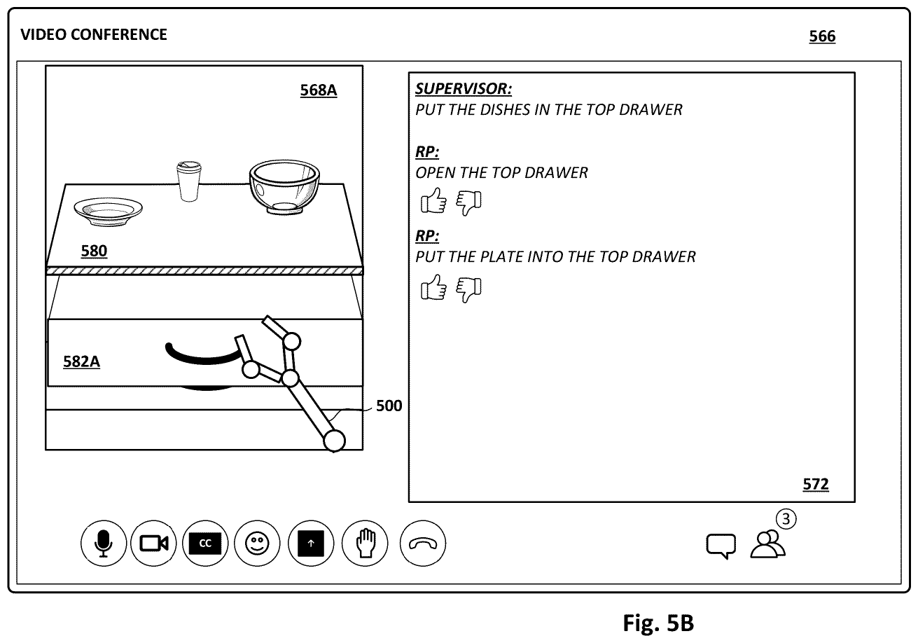

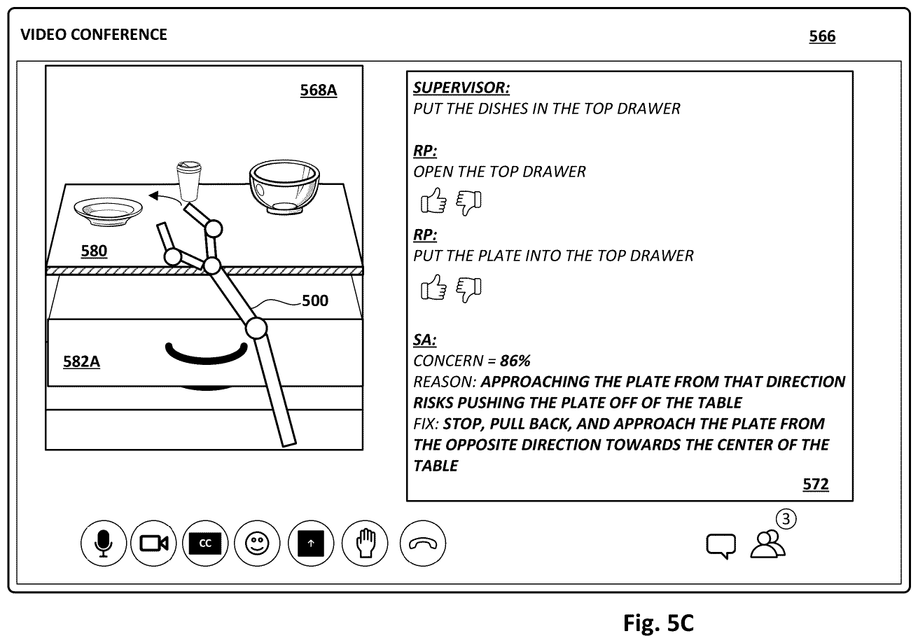

FIGS. 5A-C depict an example video conference session scenario in which a GUI 566 provides information about a video conference session in which a robot 500 is tasked with performing a high-level task, “Put the dishes in the top drawer” (seen in message exchange thread 572). In this scenario, predicted mid-level actions are processed, e.g., by robot control data generation process 152 using machine learning model(s) 154, to generate robot control data. This robot control data is then provided to robot 500, which performs the mid-level actions. As shown in the figure, a plate, bowl, and cup are arranged on top of a surface 580 of a piece of furniture that also includes a top drawer 582A and a bottom drawer 582B.

A sensor feed of robot 500 is shown in video feed 568A, but this does not necessarily require that robot 500 be a participant in the video conference session. For example, the robot's vision sensor (or a vision sensor in the robot's vicinity) may simply be communicatively coupled with (e.g., patched into) the video conference session, e.g., by sensor feed engine 126. In some implementations, the sensor data that is patched in may be a lower resolution than the native sensor data generated at the sensor (e.g., 108). This may be acceptable because robotic planner process 142 and/or safety agent process 132 may not necessarily require sensor data at the same resolution as robot 100. Moreover, streaming sensor data at a lower resolution may preserve computing resources such as network bandwidth.

In FIG. 5A, robotic planner process 142 has predicted a first mid-level action, “open the top drawer.” As shown in message exchange thread, this statement by robotic planner process 142 may be followed by graphical elements that are operable by the human participant to provide feedback, such as a “thumbs up” to approve and a “thumbs down” to disapprove. Depending on factors such as the human participant's preferences, confidence metrics associated with predicted mid-level actions, etc., it may or may not be required that the human participant approve the predicted mid-level action before robotic planner process 142 predicts a next mid-level action. If not required, then in some implementations, a predetermined amount of time (which may be adjusted based on similar factors) may elapse before robotic planner process 142 moves on to having the current mid-level action processed by robot control data generation process 152 so that robot 500 can perform the action, and predicting the next mid-level action.

In FIG. 5B, the human participant did not operate one of the graphical elements beneath the “open the top drawer” mid-level action in a predetermined amount of time. Consequently, that mid-level action was processed, e.g., by robot control data generation process 152, to generate robot control data that was used to operate robot 500 to open top drawer 582A. Next, robotic planner process 142 predicts a second mid-level action, “put the plate into the top drawer.” Once again, the human operator has an opportunity to accept or reject this second mid-level action, e.g., by actuating the thumbs up or down icon.

In FIG. 5C, robot 500 is approaching the plate to perform the second mid-level task. As shown by the arrow, robot 500 is approaching the plate from right-to-left, which also happens to be the direction in which the plate is closest to the edge of surface 580. Consequently, if robot 500 fails to engage with the plate properly, there is an increased risk that robot 500 will knock the plate off surface 580, potentially damaging the plate. Accordingly, and as shown at right, safety agent process 132 (“SA” in FIG. 5C) has entered the chat and incorporated output that includes the CRF data mentioned previously.

In particular, safety agent process 132 has indicated that the measure of concern is 86%, and that the reason behind the concern is “approaching the plate from that direction risks pushing the plate off of the table.” Finally, safety agent process 132 proposes, as alternative command(s), a fix, “stop, pull back, and approach the plate from the opposite direction towards the center of the table.” These alternative commands may then be used, e.g., by robot control data system 150, to generate a new control signal that, when used to operate robot 500, causes robot 500 to approach the plate from the opposite direction.

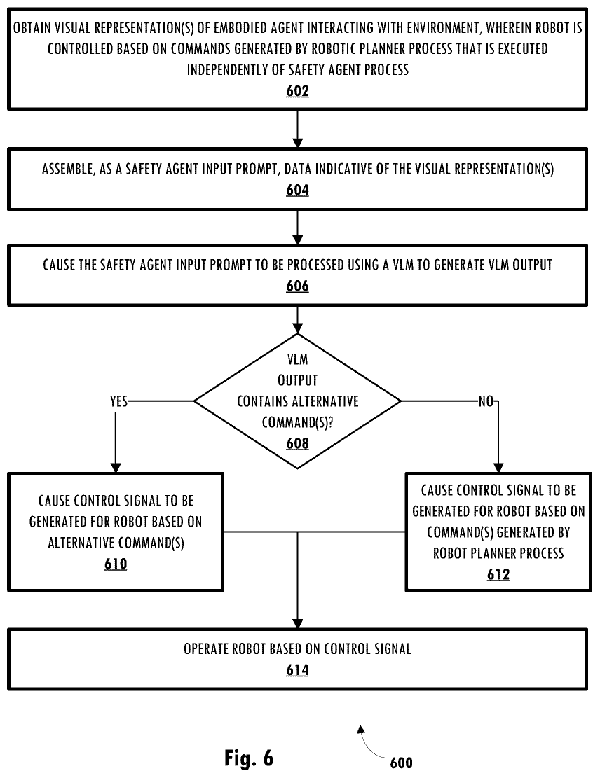

Referring now to FIG. 6, an example method 600 of practicing selected aspects of the present disclosure is described. For convenience, the operations of the flowchart are described with reference to a system that performs the operations. This system may include various components of various computer systems described herein. Moreover, while operations of method 600 are shown in a particular order, this is not meant to be limiting. One or more operations may be reordered, omitted or added.

At block 602, the system, e.g., by way of safety agent process 132, may obtain one or more visual representations of an embodied agent such as robot 100 interacting with an environment. In implementations in which the embodied agent is robot 100, robot 100 may be controlled at least in part based on commands generated by robotic planner process 142 executed by robotic planner system. Robot 100 may be a physical robot that operates in a physical environment, or a virtual robot that operates in a simulated environment. In other implementations where the embodied agent is a human, robotic planner process 142 may still provide natural language outputs describing mid-level steps; it may be up to the human to perform these steps as instructed/recommended.

In various implementations, one or more of the visual representations may be captured by a vision sensor onboard the robot and/or by a vision sensor deployed in the environment independently of the robot. In various implementations, one or more of the visual representations may take the form of a digital image captured by a digital camera, e.g., as a standalone image and/or as part of a video stream. In some implementations, one or more of the visual representations may take the form of a point cloud captured by a LIDAR sensor.

At block 604, the system, e.g., by way of safety agent process 132, may assemble, as a safety agent input prompt, data indicative of the one or more visual representations. This data indicative of the one or more visual representations may include, for example, embeddings encoded based on pixel values of digital image(s) (e.g., a video) that capture the embodied agent and/or its environment. In some implementations, a machine learning model such as a convolutional neural network (CNN) may be applied to the visual representations to generate these embeddings.

In some implementations, safety agent process 132 may further assemble, into the safety agent input prompt, one or more robot operation constraints that are generated by a separate robot operation constraint generation process. Additionally or alternatively, in some implementations, the safety agent input prompt may be further assembled to include a request to generate an indication of whether an imminent undesirable state of the environment is detected in the one or more visual representations. A non-limiting example of such an indication was provided in FIG. 5C, “Concern=86%.” Additionally or alternatively, in some implementations, the safety agent input prompt may be further assembled to include a request to generate an explanation of the detected imminent undesirable state of the environment. A non-limiting example of such an explanation was depicted in FIG. 5C: “Approaching the plate from that direction risks pushing the plate off of the table.”

In some implementations, safety agent process 132 may only generate alternative commands if the measure of concern (e.g., indication of whether an imminent undesirable state is detected) satisfies some criteria, such as a minimum risk threshold. However, given the computational costs and latency associated with prompting a generative model to generate output, in some implementations, safety agent process 132 may prompt the generative model 134 to generate alternative commands regardless of whether an imminent undesirable state is detected, e.g., regardless of the value of a measure of concern generated by safety agent process 132. This may avoid multiple applications of the generative model 134 when an imminent undesirable state is detected.

At block 606, the system, e.g., by way of safety agent process 132, may cause the safety agent input prompt to be processed using a VLM (e.g., 134, 144) to generate VLM output. In various implementations, the VLM output may include alternative command(s) for robot 100. Additionally, if requested in the safety agent input prompt, the VLM output may also include an indication of whether an imminent undesirable state of the environment is detected in the one or more visual representations and/or an explanation of the detected imminent undesirable state of the environment (the latter which may be included for debugging purposes in some cases).

At block 608, the system, e.g., by way of safety agent process 132 or robotic planner process 142, may determine whether the VLM output generated at block 606 indicates that alternative commands should be used, e.g., by their presence in the VLM output or another indication. If the answer at block 608 is yes, then method 600 may proceed to block 610.

At block 610, the system, e.g., by way of safety agent process 132, robotic planner process 142, and/or robot control data generation process 152, may cause a control signal to be generated for the robot based on the one or more alternative commands. This may be accomplished in various ways. In some implementations, safety agent process 132 may provide the alternative command(s) to robotic planner process 142 of robotic planner system 140. Robotic planner process 142 may in turn override one or more of its own commands with the alternative command(s), automatically or selectively in response to a determination that a measure of concern generated by safety agent process 132 satisfies some criteria (e.g., exceeds a risk threshold). Additionally or alternatively, safety agent process 132 may provide the alternative command(s) directly to robot control data generation process 152 that is executed independently from the robotic planner process 142, e.g., at robot control data system 150. In yet other implementations, safety agent process 132 itself may generate the control signal and transmit the control signal directly to robot 100 (or to a simulation system that is simulating robot 100 in a simulated environment).

In some implementations, safety agent process 132 may conditionally cause the control signal to be generated in response to detection of the imminent undesirable state of the environment. For example, if the measure of concern generated by safety agent process 132 fails to exceed some minimum risk threshold, then safety agent process 132 may refrain from transmitting the alternative commands to robotic planner system 140 and/or robot control data system 150.

Referring back to FIG. 6, if the answer at block 608 is no—e.g., no alternative commands contained in the VLM output, or otherwise no indication that default commands generated by the robotic planner process 142 should not be used-then method 600 may proceed to block 612. At block 612, the system, e.g., by way of safety agent process 132, robotic planner process 142, and/or robot control data generation process 152, may cause a control signal to be generated for the robot based on the commands generated by robotic planner process 142. Regardless of whether method 600 proceeded from block 608 to block 610 or block 612, at block 614, the system, e.g., by way of robot 100 itself or a simulation system simulating a robot, may be operated based on the control signal generated at block 610 or 612.

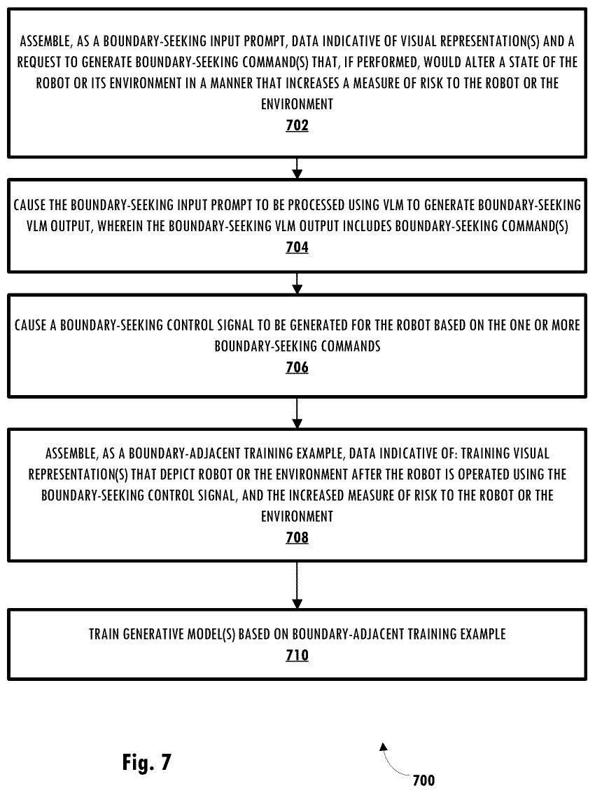

Referring now to FIG. 7, an example method 700 of practicing selected aspects of the present disclosure is described. For convenience, the operations of the flowchart are described with reference to a system that performs the operations. This system may include various components of various computer systems described herein. Moreover, while operations of method 700 are shown in a particular order, this is not meant to be limiting. One or more operations may be reordered, omitted or added.

At block 702, the system, e.g., by way of safety adversary process 132A described previously, may assemble, as a “boundary-seeking” input prompt, data indicative of one or more visual representations depicting a robot (e.g., 100, or more generally, and embodied agent) interacting with an environment. The boundary-seeking input prompt may also be assembled to include a request to generate boundary-seeking command(s). Performance of these “boundary-seeking” command(s) by robot 100 may alter a state of robot 100 and/or its environment in a manner that increases a measure of risk to robot 100 or the environment, e.g., without causing robot 100 to actually engage in deleterious behavior. As shown in FIG. 4, for instance, the goal may be to sample actions/consequences that are clustered around the boundary 476 between deleterious and non-deleterious behavior.

At block 704, the system, e.g., by way of safety adversary process 132A, may cause the boundary-seeking input prompt to be processed using a VLM (e.g., 134, 144) to generate boundary-seeking VLM output. The boundary-seeking VLM output may include, for instance, one or more boundary-seeking commands for robot 100. For example, in the torch-carrying robot example described herein, the boundary-seeking commands may cause robot 100 to carry the torch relatively close to the flammable materials, without the torch being sufficiently proximate to ignite those materials.

At block 706, safety adversary process 132A may cause a boundary-seeking control signal to be generated for the robot based on the one or more boundary-seeking commands. For example, the safety adversary process may transmit the boundary-seeking command(s) to robot control data system 150 so that robot control data generation process 152 can generate robot control data that is operable to control robot 100.

At block 708, the safety adversary process may assemble, as a boundary-adjacent training example, data indicative of training visual representation(s), captured by a vision sensor onboard robot 100 and/or elsewhere, that depict the robot or the environment as, or after, the robot is operated using the boundary-seeking control signal. The boundary-adjacent training example may also be assembled to include the increased measure of risk to the robot or the environment.

At block 710, the system, e.g., by way of training engine 148 of robotic planner system 140, may train (e.g., pretrain and/or fine-tune if already pretrained) one or more generative models, e.g., 144, based on the boundary-adjacent training example. For example, training engine 148 may train a VLM 144 by processing the training visual representation(s) to generate command(s) that should be performed by an embodied agent under the circumstances. These command(s) may then be compared to the command(s) in the boundary-adjacent training example to determine a loss function. This loss may then be minimized using techniques such as back propagation and/or gradient descent to train one or more generative models 144 used by robotic planner process 142.

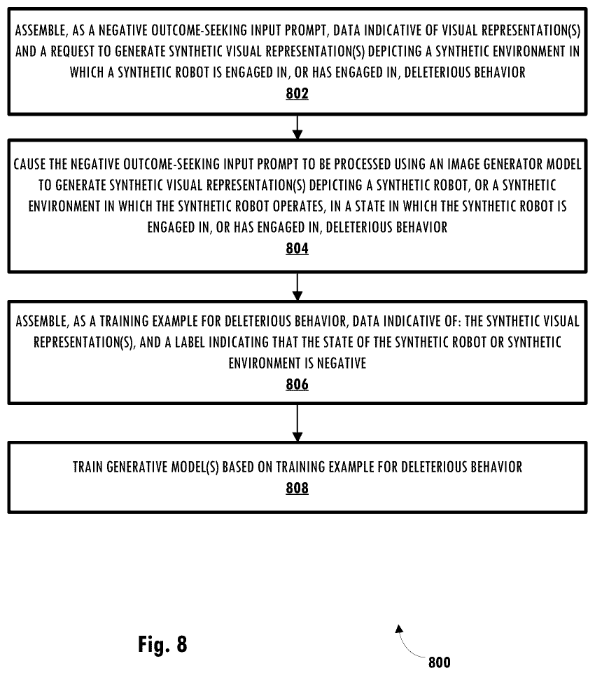

Referring now to FIG. 8, an example method 800 for dreaming process 132B to generate training examples for deleterious behavior that can then be used to train generative model(s) of robotic planner system 140 is described. For convenience, the operations of the flowchart are described with reference to a system that performs the operations. This system may include various components of various computer systems described herein, particularly dreaming process 132B. Moreover, while operations of method 800 are shown in a particular order, this is not meant to be limiting. One or more operations may be reordered, omitted or added.

At block 802, dreaming process 132B may assemble, as a negative outcome-seeking input prompt, data indicative of visual representation(s) depicting robot 100 interacting with an environment. The negative outcome-seeking input prompt may also be assembled to include a request to generate synthetic visual representation(s) depicting a synthetic environment in which a synthetic robot is engaged in, or has engaged in, deleterious behavior.

At block 804, the system, e.g., by way of the simulation training process, may cause the negative outcome-seeking input prompt to be processed using an image generator model (e.g., a diffusion model such as Imagen 3) to generate one or more synthetic visual representations depicting a synthetic robot, or a synthetic environment in which the synthetic robot operates, in a state in which the synthetic robot is engaged in, or has engaged in, deleterious behavior. In various implementations, the synthetic robot and/or environment may at least somewhat resemble the real robot and/or environment because the image generator model was conditioned on the visual representation(s) of the real robot in its environment. In the robot-torch example described herein, the synthetic image may depict a synthetic robot that has carried a lit torch too closely to flammable materials, causing those materials to ignite.

At block 806, dreaming process 132B may assemble, as a training example for deleterious behavior, data indicative of: the synthetic visual representation(s), and data indicative of command(s) for the embodied agent to perform in the environment portrayed in the synthetic visual representation(s) (e.g., commands that, if performed, may ameliorate, avoid, and/or reduce the severity of deleterious outcome(s)). For example, dreaming process 132B may use a VLM 134 to process an input prompt that includes the synthetic visual representation(s) and a request to predict commands that, if performed, may ameliorate, avoid, and/or reduce the severity of deleterious outcome(s). Based on this processing, dreaming process 132B may provide the training example for deleterious behavior that includes the synthetic visual representation(s) and the predicted command(s) to training engine 148 of robotic planner system 140.

At block 808, training engine 148 of robotic planner system 140 may train (e.g., pretrain and/or fine-tune if already pretrained) one or more generative models (e.g., 144) based on the training example for deleterious behavior. For example, training engine 148 may train a VLM 144 by processing the synthetic visual representation(s) to generate command(s) that should be performed by an embodied agent under the circumstances. These command(s) may then be compared to the command(s) in the training example for deleterious behavior (which recall were generated by the separate dreaming process 132B) to determine a loss function. This loss may then be minimized using techniques such as back propagation and/or gradient descent to train one or more generative models 144 used by robotic planner process 142.

Additionally or alternatively, in some implementations, techniques such as reinforcement learning based on human feedback (RLHF) may be employed. For example, humans may label training examples for deleterious behavior generated by dreaming process 132B as positive or negative. These labels may then be used to train a separate reward function. This reward function may then be used to perform semi-supervised learning of generative model(s) of robotic planner system 140.

FIG. 9 is a block diagram of an example computer system 910. Computer system 910 typically includes at least one processor 914 which communicates with a number of peripheral devices via bus subsystem 912. These peripheral devices may include a storage subsystem 924, including, for example, a memory subsystem 925 and a file storage subsystem 926, user interface output devices 920, user interface input devices 922, and a network interface subsystem 916. The input and output devices allow user interaction with computer system 910. Network interface subsystem 916 provides an interface to outside networks and is coupled to corresponding interface devices in other computer systems.

User interface input devices 922 may include a keyboard, pointing devices such as a mouse, trackball, touchpad, or graphics tablet, a scanner, a touch screen incorporated into the display, audio input devices such as voice recognition systems, microphones, and/or other types of input devices. In general, use of the term “input device” is intended to include all possible types of devices and ways to input information into computer system 910 or onto a communication network.

User interface output devices 920 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computer system 910 to the user or to another machine or computer system.

Storage subsystem 924 stores programming and data constructs that provide the functionality of some or all of the modules described herein. For example, the storage subsystem 924 may include the logic to perform selected aspects of method 600, 700, and/or 800, and/or to implement one or more aspects of robot 100 or systems 120, 130, 140, and/or 150. Memory 925 used in the storage subsystem 924 can include a number of memories including a main random-access memory (RAM) 930 for storage of instructions and data during program execution and a read only memory (ROM) 932 in which fixed instructions are stored. A file storage subsystem 926 can provide persistent storage for program and data files, and may include a hard disk drive, a CD-ROM drive, an optical drive, or removable media cartridges. Modules implementing the functionality of certain implementations may be stored by file storage subsystem 926 in the storage subsystem 924, or in other machines accessible by the processor(s) 914.

Bus subsystem 912 provides a mechanism for letting the various components and subsystems of computer system 910 communicate with each other as intended. Although bus subsystem 912 is shown schematically as a single bus, alternative implementations of the bus subsystem may use multiple buses.

Computer system 910 can be of varying types including a workstation, server, computing cluster, blade server, server farm, smart phone, smart watch, smart glasses, set top box, tablet computer, laptop, or any other data processing system or computing device. Due to the ever-changing nature of computers and networks, the description of computer system 910 depicted in FIG. 9 is intended only as a specific example for purposes of illustrating some implementations. Many other configurations of computer system 910 are possible having more or fewer components than the computer system depicted in FIG. 9.

In some implementations, a computer implemented method may be provided that includes: A method implemented using one or more processors and comprising: obtaining, by a safety agent process, one or more visual representations of a robot interacting with an environment, wherein the robot is controlled at least in part based on commands generated by a robotic planner process that is executed by one or more of the processors; assembling, by the safety agent process as a safety agent input prompt, data indicative of the one or more visual representations; causing, by the safety agent process, the safety agent input prompt to be processed using a vision language model (VLM) to generate VLM output; and responsive to the VLM output including one or more alternative commands for the robot, causing, by the safety agent process, a control signal to be generated for the robot based on the one or more alternative commands.

In various implementations, the robot may be a physical robot and the environment is a physical environment. In various implementations, the robot may be a virtual robot and the environment is a simulated environment. In various implementations, one or more of the visual representations may be captured by a vision sensor onboard the robot. In various implementations, one or more of the visual representations may be captured by a vision sensor deployed in the environment independently of the robot. In various implementations, one or more of the visual representations include a digital image captured by a digital camera or a point cloud captured by a light detection and ranging (LIDAR) sensor.

In various implementations, causing the control signal to be generated may include providing the one or more alternative commands to the robotic planner process. In various implementations, causing the control signal to be generated may include providing the one or more alternative commands to a robot control data generation process that is executed independently from the robotic planner process.

In various implementations, the control signal may be generated by the safety agent process. In various implementations, the safety agent process may provide the control signal to the robot.

In various implementations, the safety agent input prompt may be assembled to include a request to generate an indication of whether an imminent undesirable state of the environment is detected in the one or more visual representations. In various implementations, the safety agent process may cause the control signal to be generated in response to detection of the imminent undesirable state of the environment. In various implementations, the safety agent input prompt may be further assembled to include a request to generate an explanation of the detected imminent undesirable state of the environment. In various implementations, the robotic planner process may be operated independently of the safety agent process.

In various implementations, the method may include: causing one or more video conference clients of a video conference session to render output that includes one or more sensor feeds, wherein one or more of the sensor feeds include the one or more visual representations of the robot interacting with the environment; communicatively coupling the safety agent process and the robotic planner process to the video conference session; receiving, from a video conference client operated by a first participant in the video conference session, a natural language request for the robot to perform a high-level task; and causing the robotic planner process to process the natural language request using a first machine learning model to generate the commands.

In various implementations, the communicatively coupling may include registering, as an additional participant of the video conference session, a video conference client associated with the robotic planner process. In various implementations, the communicatively coupling may include registering, as an additional participant of the video conference session, a video conference client associated with the safety agent process. In various implementations, causing the control signal to be generated may include the video conference client associated with the safety agent process providing the one or more alternative commands to the video conference client associated with the robotic planner process.

In various implementations, the method may include assembling, by a safety adversary process as a boundary-seeking input prompt, data indicative of the one or more visual representations and a request to generate one or more boundary-seeking commands that, if performed by the robot, would alter a state of the robot or its environment in a manner that increases a measure of risk to the robot or the environment; causing, by the safety adversary process, the boundary-seeking input prompt to be processed using the same VLM or a different VLM to generate boundary-seeking VLM output, wherein the boundary-seeking VLM output includes one or more boundary-seeking commands for the robot; and causing, by the safety adversary process, a boundary-seeking control signal to be generated for the robot based on the one or more boundary-seeking commands. In various implementations, the method may further include assembling, as a boundary-adjacent training example, data indicative of: one or more training visual representations that depict the robot or the environment after the robot is operated using the boundary-seeking control signal, the increased measure of risk to the robot or the environment; and training or fine-tuning one or more generative models based on the boundary-adjacent training example.

In various implementations, the method may include assembling, by a simulation training process as a negative outcome-seeking input prompt, data indicative of the one or more visual representations and a request to generate one or more synthetic visual representations depicting a synthetic environment in which a synthetic robot is engaged in, or has engaged in, deleterious behavior; causing, by the simulation training process, the negative outcome-seeking input prompt to be processed using an image generator model to generate one or more synthetic visual representations depicting a synthetic robot, or a synthetic environment in which the synthetic robot operates, in a state in which the synthetic robot is engaged in, or has engaged in, deleterious behavior; assembling, as a training example for deleterious behavior, data indicative of: the one or more synthetic visual representations, and a label indicating that the state of the synthetic robot or synthetic environment is negative; and training or fine-tuning one or more generative models based on the training example for deleterious behavior.

In various implementations, one or more of the generative models may include the VLM. In various implementations, one or more of the generative models may include a generative model that is used by the robotic planner process.

In various implementations, the safety agent process may use a different VLM than the robotic planner process. In various implementations, the safety agent process may use the same VLM as the robotic planner process. In various implementations, the safety agent input prompt may be further assembled to include one or more robot operation constraints that are generated by a separate robot operation constraint generation process.

In another aspect, a method may be implemented using one or more processors and may include: assembling, by a safety adversary process as a boundary-seeking input prompt, data indicative of one or more visual representations depicting an embodied agent interacting with an environment and a request to generate one or more boundary-seeking commands that, if performed by the embodied agent, would alter a state of the embodied agent or its environment in a manner that increases a measure of risk to the embodied agent or the environment; causing, by the safety adversary process, the boundary-seeking input prompt to be processed using a vision language model (VLM) to generate boundary-seeking VLM output, wherein the boundary-seeking VLM output includes one or more boundary-seeking commands for the embodied agent; and causing, by the safety adversary process, one or more of the boundary-seeking commands to be presented to the embodied agent at one or more output devices.

In various implementations, the method may include assembling, as a boundary-adjacent training example, data indicative of: (i) one or more training visual representations that depict the embodied agent or the environment as, or after, the embodied agent follows one or more of the boundary-seeking commands, and (ii) the increased measure of risk to the embodied agent or the environment; and training or fine-tuning one or more generative models based on the boundary-adjacent training example.

In another aspect, a method may be implemented using one or more processors and may include: assembling, by a simulation training process as a negative outcome-seeking input prompt, data indicative of one or more visual representations depicting a robot interacting with an environment and a request to generate one or more synthetic visual representations depicting a synthetic environment in which a synthetic robot is engaged in, or has engaged in, deleterious behavior; causing, by the simulation training process, the negative outcome-seeking input prompt to be processed using an image generator model to generate one or more synthetic visual representations depicting a synthetic robot, or a synthetic environment in which the synthetic robot operates, in a state in which the synthetic robot is engaged in, or has engaged in, deleterious behavior; assembling, as a training example for deleterious behavior, data indicative of: the one or more synthetic visual representations, and a label indicating that the state of the synthetic robot or synthetic environment is negative; and training or fine-tuning one or more generative models based on the training example for deleterious behavior.

In various implementations, one or more of the generative models may include a vision language model (VLM). In various implementations, one or more of the generative models may include a generative model that is used by a robotic planner process that generates commands for the robot.

In another aspect, a method may be implemented using one or more processors and may include: obtaining, by a safety agent process, one or more visual representations of an embodied agent interacting with an environment, wherein the embodied agent is controlled at least in part based on commands generated by a planner process that is executed by one or more of the processors; assembling, by the safety agent process as a safety agent input prompt, data indicative of the one or more visual representations; causing, by the safety agent process, the safety agent input prompt to be processed using a vision language model (VLM) to generate VLM output; and responsive to the VLM output including one or more alternative commands for the embodied agent, causing, by the safety agent process, one or more of the alternative commands to be provided to the embodied agent using one or more output devices.

Other implementations may include a transitory or non-transitory computer readable storage medium storing instructions executable by a processor to perform a method such as one or more of the methods described above. Yet another implementation may include a control system including memory and one or more processors operable to execute instructions, stored in the memory, to implement one or more modules or engines that, alone or collectively, perform a method such as one or more of the methods described above.

It should be appreciated that all combinations of the foregoing concepts and additional concepts described in greater detail herein are contemplated as being part of the subject matter disclosed herein. For example, all combinations of claimed subject matter appearing at the end of this disclosure are contemplated as being part of the subject matter disclosed herein.

While several implementations have been described and illustrated herein, a variety of other means and/or structures for performing the function and/or obtaining the results and/or one or more of the advantages described herein may be utilized, and each of such variations and/or modifications is deemed to be within the scope of the implementations described herein. More generally, all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific implementations described herein. It is, therefore, to be understood that the foregoing implementations are presented by way of example only and that, within the scope of the appended claims and equivalents thereto, implementations may be practiced otherwise than as specifically described and claimed. Implementations of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

What is claimed is:

1. A method implemented using one or more processors and comprising:
obtaining, by a safety agent process, one or more visual representations of a robot interacting with an environment, wherein the robot is controlled at least in part based on commands generated by a robotic planner process that is executed by one or more of the processors;
assembling, by the safety agent process as a safety agent input prompt, data indicative of the one or more visual representations;
causing, by the safety agent process, the safety agent input prompt to be processed using a vision language model (VLM) to generate VLM output; and
responsive to the VLM output including one or more alternative commands for the robot, causing, by the safety agent process, a control signal to be generated for the robot based on the one or more alternative commands.

2. The method of claim 1, wherein the robot is a physical robot and the environment is a physical environment.

3. The method of claim 1, wherein the robot is a virtual robot and the environment is a simulated environment.

4. The method of claim 1, wherein one or more of the visual representations are captured by a vision sensor onboard the robot.

5. The method of claim 1, wherein one or more of the visual representations are captured by a vision sensor deployed in the environment independently of the robot.

6. The method of claim 1, wherein one or more of the visual representations comprise a digital image captured by a digital camera.

7. The method of claim 1, wherein one or more of the visual representations comprise a point cloud captured by a light detection and ranging (LIDAR) sensor.

8. The method of claim 1, wherein causing the control signal to be generated comprises providing the one or more alternative commands to the robotic planner process.

9. The method of claim 1, wherein causing the control signal to be generated comprises providing the one or more alternative commands to a robot control data generation process that is executed independently from the robotic planner process.

10. The method of claim 1, wherein the control signal is generated by the safety agent process.

11. The method of claim 10, wherein the safety agent process provides the control signal to the robot.

12. The method of claim 1, wherein the safety agent input prompt is assembled to include a request to generate an indication of whether an imminent undesirable state of the environment is detected in the one or more visual representations.

13. The method of claim 12, wherein the safety agent process causes the control signal to be generated in response to detection of the imminent undesirable state of the environment.

14. The method of claim 13, wherein the safety agent input prompt is further assembled to include a request to generate an explanation of the detected imminent undesirable state of the environment.

15. The method of claim 1, wherein the robotic planner process is operated independently of the safety agent process.

16. The method of claim 1, further comprising
causing one or more video conference clients of a video conference session to render output that includes one or more sensor feeds, wherein one or more of the sensor feeds include the one or more visual representations of the robot interacting with the environment;
communicatively coupling the safety agent process and the robotic planner process to the video conference session;
receiving, from a video conference client operated by a first participant in the video conference session, a natural language request for the robot to perform a high-level task; and
causing the robotic planner process to process the natural language request using a first machine learning model to generate the commands.

17. The method of claim 16, wherein the communicatively coupling comprises registering, as an additional participant of the video conference session, a video conference client associated with the robotic planner process.

18. The method of claim 16, wherein the communicatively coupling comprises registering, as an additional participant of the video conference session, a video conference client associated with the safety agent process.

19. The method of claim 18, wherein causing the control signal to be generated comprises the video conference client associated with the safety agent process providing the one or more alternative commands to the video conference client associated with the robotic planner process.

20. The method of claim 1, further comprising:
assembling, by a safety adversary process as a boundary-seeking input prompt, data indicative of the one or more visual representations and a request to generate one or more boundary-seeking commands that, if performed by the robot, would alter a state of the robot or its environment in a manner that increases a measure of risk to the robot or the environment;
causing, by the safety adversary process, the boundary-seeking input prompt to be processed using the same VLM or a different VLM to generate boundary-seeking VLM output, wherein the boundary-seeking VLM output includes one or more boundary-seeking commands for the robot; and
causing, by the safety adversary process, a boundary-seeking control signal to be generated for the robot based on the one or more boundary-seeking commands.
